(19) United States
(12) Patent Application Publication
(10) Pub. No.: US 2019/0096003 A1
(43) Pub. Date: Mar. 28, 2019

(54) METHOD AND SYSTEM FOR PROVIDING AN EMBEDDED WEB BROWSER TO ASSIST RETRIEVING FINANCIAL DOCUMENT DATA DURING A FINANCIAL MANAGEMENT INTERVIEW

(71) Applicant: Intuit Inc., Mountain View, CA (US)

(72) Inventors: Grace Pariante, Palo Alto, CA (US); Chang Ting "CT" Yu, Escondido, CA (US); Suman Yadav, Bangalore (IN); Swathi M, Bangalore (IN); Muniyaraj Samayavel, Bangalore (IN); Bobby G. Bray, JR., San Diego, CA (US)

(73) Assignee: Intuit Inc., Mountain View, CA (US)

(21) Appl. No.: 15/817,645

(22) Filed: Nov. 20, 2017

(30) Foreign Application Priority Data
Sep. 28, 2017 (IN) 201721034615

(51) Int. Cl. G06Q 40/00; G06F 17/30

(52) U.S. Cl. CPC G06Q 40/123; G06F 17/30011

(57) ABSTRACT

A method and system assists users of a user of a financial management system to retrieve financial document data from third-party websites during a financial management interview presented to the user by the financial management system via a primary web browser executed in a computing environment of the user. The method and system implement an embedded web browser in the primary web browser of the user and assist the user to download the financial document data without switching from the current tab of the primary web browser through which the user receives the financial management interview.

### BACKGROUND

Federal and State Tax law have become so complex that it is now estimated that each year Americans alone use over 6 billion person hours, and spend nearly 4 billion dollars, in an effort to comply with Federal and State Tax statutes. Given this level of complexity and cost, it is not surprising that more and more taxpayers find it necessary to obtain help, in one form or another, to prepare their taxes. Tax return preparation systems, such as tax return preparation software programs and applications, represent a highly accessible and affordable source of tax preparation assistance. However, traditional tax return preparation systems can also be highly inconvenient and confusing.

For instance, many traditional tax return preparation systems require users to retrieve paper or electronic versions of tax documents and to manually enter values from the paper or electronic versions of tax documents into the tax return preparation system. In some cases, uses may undergo a tax return preparation interview with a traditional tax return preparation system via a web browser. If the user needs to retrieve an electronic version of a tax document, the user typically will open a new tab in the web browser or an entirely new instance of the web browser in order to access a third-party website to download the electronic version of the tax document. If the user needs to retrieve many electronic documents from various third parties, the user can become frustrated by the frequent switching between tabs or browser windows in order to download electronic versions of tax documents. In many cases, users become tired of this process and may abandon the traditional tax return preparation system. In other cases, users may mistakenly or enter a web address for a third-party website into the address bar of the web browser tab in which the user is currently participating in a tax return preparation interview. This can accidentally cause the users to navigate away from the website of the traditional tax return preparation system, resulting in the loss of unsaved progress in the tax return preparation interview. The users may need to log back into the website of the tax return preparation system and again provide authentication credentials. These frustrated and confused users may then decide to abandon the electronic tax return preparation system in favor of other methods of preparing their taxes. Furthermore, the repetition of portions of the tax return preparation interview, as well as the number of times that user must upload new documents to the tax return preparation system, wastes processing resources of the tax return preparation system.

The drawbacks set forth above are not limited to tax return preparation systems. Many electronic financial management systems other than tax return preparation systems suffer from the same or similar drawbacks.

Consequently, there is a long standing technical problem in the financial management system arts in the form of a need to provide more efficient assistance to users retrieve financial documents from third parties and to incorporate these financial documents into the financial management system.

### SUMMARY

Embodiments of the present disclosure address some of the shortcomings associated with traditional electronic financial management systems by providing methods and systems for facilitating the efficient and convenient retrieval of financial document data within a financial management interview. A financial management system in accordance with the present disclosure provides a financial management interview to a user via a primary web browser executed in a computing environment of the user. During the financial management interview, the user may need to retrieve, from a third-party website, financial document data corresponding to electronic versions of financial documents of the user. When this situation arises, the financial management system advantageously embeds a second web browser in the tab of the web browser in which the user is receiving the financial management interview from the financial management system. The financial management system opens the embedded web browser to the website of the third-party from which the financial related documents will be retrieved. The user can sign into the third-party website and access the financial document data via the embedded web browser without leaving the web page in which the user is receiving the financial management interview.

Embodiments of the present disclosure enable the user to retrieve financial document data from third-party websites without switching to a new tab in the web browser, without opening a new instance of the web browser, and without opening a separate web browser. This reduces the likelihood that the user will accidentally navigate away from the web page of the financial management system and lose unsaved progress while trying to retrieve financial document data. This enhances the efficiency of the financial management system by reducing the occurrence of duplicated efforts in redoing unsaved portions of the financial management interview. This saves the user's time and prevents frustration and confusion. Therefore, the disclosed embodiments provide one or more technical solutions to the technical problem of inefficient financial management systems by providing an embedded web browser in a primary web browser from which the user is receiving a financial management interview in order to assist users to retrieve financial document data from third-party websites.

In one embodiment, the financial management system further enhances the financial management interview process by generating user action tracking data by recording the steps taken by users in the embedded web browser to retrieve financial document data from third-party websites. Because thousands of users may need to access many of the same websites in order to retrieve various financial document data, the financial management system can build a script for retrieving each type of financial document data from each website. The financial management system can build the script by tracking the steps that each user takes in retrieving specific kinds of financial document data from various third-party websites via the embedded web browser. When the financial management system has generated user action tracking data related to actions taken by a sufficient number of users to build a reliable script for retrieving a particular kind of financial document data from a particular third-party website, the financial management system generates script data for automatically retrieving the particular kind of financial document data from the particular third-party website. Additionally, the financial management system can generate the user action tracking data in a manner that protects the user's anonymity by not collecting any personally identifying information related to the user. The financial management system can provide notifications to the user assuring the user that no personal information will be collected in the process.

In one embodiment, after the financial management system has generated script data for automatically retrieving a particular kind of financial document data for a particular third-party website, the financial management system can retrieve the particular kind of financial document data from the particular third-party website in an automated manner for future users of the financial management system. When the financial management system determines that the user needs to retrieve financial document data for which the financial management system has already generated a script based on the user action tracking data, the financial management system can open the embedded web browser within the tab of the primary web browser from which the user is receiving the financial management interview. The financial management system opens the embedded web browser to the website of the third-party. After the user has provided authentication data to log into the third-party website, the financial management system executes the script data for retrieving the financial document data within the embedded web browser. The financial management system initiates the download of the financial document data by executing the script data within the embedded web browser. This further enhances the efficiency of the financial management system by reducing the number of actions that need to be taken by the user in order to retrieve financial document data.

In one embodiment, the financial management system downloads the financial document data directly to the financial management system from the third-party website via the embedded web browser. Thus, when the user navigates to the financial document data on the third-party website via the embedded web browser and selects to download the financial document data, or when the financial management system executes a script to find and download the financial document data via the embedded web browser, the financial management system downloads the financial document data directly to the financial management system. This eliminates the need for the user to upload the financial document data to the financial management system after retrieving the financial document data because the financial management system already has obtained the financial document data. The financial management system can also download the financial document data to a computing environment of the user.

In one embodiment, the financial management system automatically imports data from the financial document data into data fields of one or more financial forms to be filled out as part of the financial management interview process. Thus, instead of forcing the user to manually enter data from the financial document data into the financial management system via the web browser, the financial management system can analyze the financial document data and extract selected information from the financial document data and populate data fields of the one or more financial forms with the selected information. This further improves the efficiency of the financial management system by reducing the number of data entry requests that need to be made of the user. This can additionally improve the efficiency of the financial management system by reducing errors that can be introduced into the financial management interview process when users mistype data as they enter the data into data fields presented in the financial management interview process. Furthermore, this helps provide incentive for the users to complete the financial management interview process.

In one embodiment, the financial management system presents notification data to the user in the web browser related to actions being taken in the embedded web browser. The notification data can include a notification that the download of the financial document data has been initiated. The notification data can include a notification of the progress of the download of the financial document data. The notification data can include a notification that the download of a financial document data has been successfully completed. The notification data can include a notification that the download has failed. The notification data can include a notification that the financial document data selected by the user, or by the script, is not the correct financial document data.

In one embodiment, the financial management system is a tax return preparation system and the financial management interview is a tax return preparation interview. The financial document data can correspond to tax related document data. For example, during the tax return preparation interview, the tax return preparation system may determine that the user needs to retrieve, from a third-party website, tax related document data related to one or more tax forms of the user. The tax return preparation system can open the embedded web browser within the primary browser by which the user is receiving the tax return preparation interview and can prompt the user to retrieve the tax related document data. Additionally, or alternatively, the tax return preparation system can open the embedded web browser to an authentication page of the third-party website, and, after the user has provided authentication data to log into the third-party website, the tax return preparation system can execute a previously generated script to automatically download the tax related document data from the third-party website. The tax return preparation system can then import information from the tax related document data into data fields of tax forms being prepared as part of the tax return preparation interview.

In one embodiment, principles of the present disclosure can extend the systems other than financial management systems. Principles of the present disclosure can extend to a situation in which a user may need to access a third-party website to retrieve data.

In one embodiment, the financial management system presents the financial management interview within a dedicated software application rather than in a web browser. The dedicated software application is executed, at least in part, in the computing environment of the user. The financial management system implements the embedded web browser within the dedicated software application and navigates to the third-party website via the embedded web browser in the dedicated software application to assist the user to retrieve financial document data as set forth above.

The disclosed embodiments provide one or more technical solutions to the technical problem of financial management systems that are not able to adequately automate the process of retrieving financial document data from third-party websites as part of a financial management interview. The one or more technical solutions include opening an embedded web browser within a web browser, or within a tab of a web browser by which the user is currently receiving a financial management interview and assisting the user to retrieve and import the financial document data for incorporation into the financial management interview process. These and other embodiments of the financial management system are discussed in further detail below.

Facilitating the efficient and convenient retrieval of financial document data within a financial management interview is a technical solution to a long standing technical problem and is not an abstract idea for at least the following reasons. First, facilitating the efficient and convenient retrieval of financial document data within a financial management interview is not an abstract idea because it is not merely an idea itself (e.g., can be performed mentally or using pen and paper). Second, facilitating the efficient and convenient retrieval of financial document data within a financial management interview is not an abstract idea because it is not a fundamental economic practice (e.g., is not merely creating a contractual relationship, hedging, mitigating a settlement risk, etc.). Third, facilitating the efficient and convenient retrieval of financial document data within a financial management interview is not an abstract idea because it is not a method of organizing human activity (e.g., managing a game of bingo). Fourth, although mathematics may be used to generate an analytics model, the disclosed and claimed methods and systems of facilitating the efficient and convenient retrieval of financial document data within a financial management interview are not an abstract idea because the methods and systems are not simply a mathematical relationship/formula.

Facilitating the efficient and convenient retrieval of financial document data within a financial management interview is not an abstract idea because facilitating efficient and convenient retrieval of financial document data within a financial management interview allows for significant improvement to the technical fields of data processing, data transmission, electronic financial management, and user experience, according to one embodiment. The present disclosure adds significantly to the field of electronic financial management because the disclosed financial management system: decreases the number of times that a user will be asked to provide data, decreases the likelihood that the system will have to repeat portions of the financial management interview due to inadvertent navigation away from a webpage of the financial management system, decreases the likelihood the user will become frustrated and confused, decreases the likelihood of user errors in data entry, and decreases the amount of time users spend in a financial management interview, according to one embodiment.

As a result, embodiments of the present disclosure allow for reduced use of processor cycles in certain operations, reduced use of communication and processing bandwidth, reduced amount of memory needed and used in a financial management interview, and reduced power consumption, by efficiently and conveniently automating certain portions of the financial management interview process in a manner that minimizes confusion and effort on the part of the user. Consequently, computing and communication systems implementing or providing the embodiments of the present disclosure are transformed into more operationally efficient devices and systems.

In addition to improving overall computing performance, facilitating the efficient and convenient retrieval of financial document data within a financial management interview significantly improves the field of financial management systems, by reducing the amount of time it takes to progress a user through a financial management interview, according to one embodiment. Therefore, both human and non-human resources are utilized more efficiently. Furthermore, by facilitating the efficient and convenient retrieval of financial document data within a financial management interview, loyalty in the financial management system is increased, which results in repeat customers, efficient financial management interviews such as tax return preparation interviews, and reduced abandonment of use of the financial management system, according to one embodiment.

### BRIEF DESCRIPTION OF THE DRAWINGS

FIG. 1 is a block diagram of software architecture for facilitating the efficient and convenient retrieval of financial document data within a financial management interview, in accordance with one embodiment.

FIGS. 2A-2K are illustrations of financial management interview content presented in a primary browser of a user computing environment by a financial management system for facilitating the efficient and convenient retrieval of financial document data within a financial management interview, in accordance with one embodiment, according to various embodiments.

FIG. 3 is a flow diagram of a process for facilitating the efficient and convenient retrieval of financial document data within a financial management interview, in accordance with one embodiment.

FIG. 4 is a flow diagram of a process for facilitating the efficient and convenient retrieval of financial document data within a financial management interview, in accordance with one embodiment.

Common reference numerals are used throughout the FIGS. and the detailed description to indicate like elements. One skilled in the art will readily recognize that the above FIGS. are examples and that other architectures, modes of operation, orders of operation, and elements/functions can be provided and implemented without departing from the characteristics and features of the invention, as set forth in the claims.

### DETAILED DESCRIPTION

Embodiments will now be discussed with reference to the accompanying FIGS., which depict one or more exemplary embodiments. Embodiments may be implemented in many different forms and should not be construed as limited to the embodiments set forth herein, shown in the FIG. s, and/or described below. Rather, these exemplary embodiments are provided to allow a complete disclosure that conveys the principles of the invention, as set forth in the claims, to those of skill in the art.

Herein, the term “production environment” includes the various components, or assets, used to deploy, implement, access, and use, a given application as that application is intended to be used. In various embodiments, production environments include multiple assets that are combined, communicatively coupled, virtually and/or physically connected, and/or associated with one another, to provide the production environment implementing the application.

As specific illustrative examples, the assets making up a given production environment can include, but are not limited to, one or more computing environments used to implement the application in the production environment such as a data center, a cloud computing environment, a dedicated hosting environment, and/or one or more other computing environments in which one or more assets used by the application in the production environment are implemented; one or more computing systems or computing entities used to implement the application in the production environment; one or more virtual assets used to implement the application in the production environment; one or more supervisory or control systems, such as hypervisors, or other monitoring and management systems, used to monitor and control assets and/or components of the production environment; one or more communications channels for sending and receiving data used to implement the application in the production environment; one or more access control systems for limiting access to various components of the production environment, such as firewalls and gateways; one or more traffic and/or routing systems used to direct, control, and/or buffer, data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the application in the production environment; one or more databases used to store data in the production environment; one or more internal or external services used to implement the application in the production environment; one or more backend systems, such as backend servers or other hardware used to process data and implement the application in the production environment; one or more software systems used to implement the application in the production environment; and/or any other assets/components making up an actual production environment in which an application is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

In various embodiments, each computing environment includes allocated assets and virtual assets associated with, and controlled or used to create, and/or deploy, and/or operate an application.

In various embodiments, one or more cloud computing environments are used to create, and/or deploy, and/or operate an application that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given application or service may utilize, and interface with, multiple cloud computing environments, such as multiple VPCs, in the course of being created, and/or deployed, and/or operated.

As used herein, the term “virtual asset” includes any virtualized entity or resource, and/or virtualized part of an actual, or “bare metal” entity. In various embodiments, the virtual assets can be, but are not limited to, virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through, a cloud computing environment; and/or any other virtualized assets and/or sub-systems of “bare metal” physical devices such as mobile devices, remote sensors, laptops, desktops, point-of-sale devices, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing, can be implemented as one or more virtual assets.

In one embodiment, two or more assets, such as computing systems and/or virtual assets, and/or two or more computing environments, are connected by one or more communications channels including but not limited to, Secure Sockets Layer communications channels and various other secure communications channels, and/or distributed computing system networks, such as, but not limited to: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

As used herein, the term “user” includes, but is not limited to, any party, parties, entity, and/or entities using, or otherwise interacting with any of the methods or systems discussed herein. For instance, in various embodiments, a user can be, but is not limited to, a person, a commercial entity, an application, a service, and/or a computing system.

As used herein, the term “relationship(s)” includes, but is not limited to, a logical, mathematical, statistical, or other association between one set or group of information, data, and/or users and another set or group of information, data, and/or users, according to one embodiment. The logical, mathematical, statistical, or other association (i.e., relationship) between the sets or groups can have various ratios or correlation, such as, but not limited to, one-to-one, multiple-to-one, one-to-multiple, multiple-to-multiple, and the like, according to one embodiment. As a non-limiting example, if the disclosed tax return preparation system determines a relationship between a first group of data and a second group of data, then a characteristic or subset of a first group of data can be related to, associated with, and/or correspond to one or more characteristics or subsets of the second group of data, or vice-versa, according to one embodiment. Therefore, relationships may represent one or more subsets of the second group of data that are associated with one or more subsets of the first group of data, according to one embodiment. In one embodiment, the relationship between two sets or groups of data includes, but is not limited to similarities, differences, and correlations between the sets or groups of data.

As used herein, the terms “interview” and “interview process” include, but are not limited to, an electronic, software-based, and/or automated delivery of multiple questions to a user and an electronic, software-based, and/or automated receipt of responses from the user to the questions, according to various embodiments.

As used herein, the term web browser includes, but are not limited to, software applications that enable computing systems to access the internet. Examples of web browsers include, but are not limited to, Microsoft Internet Explorer, Microsoft Edge, Apple Safari, Google Chrome, Mozilla Firefox, and mobile browsers.

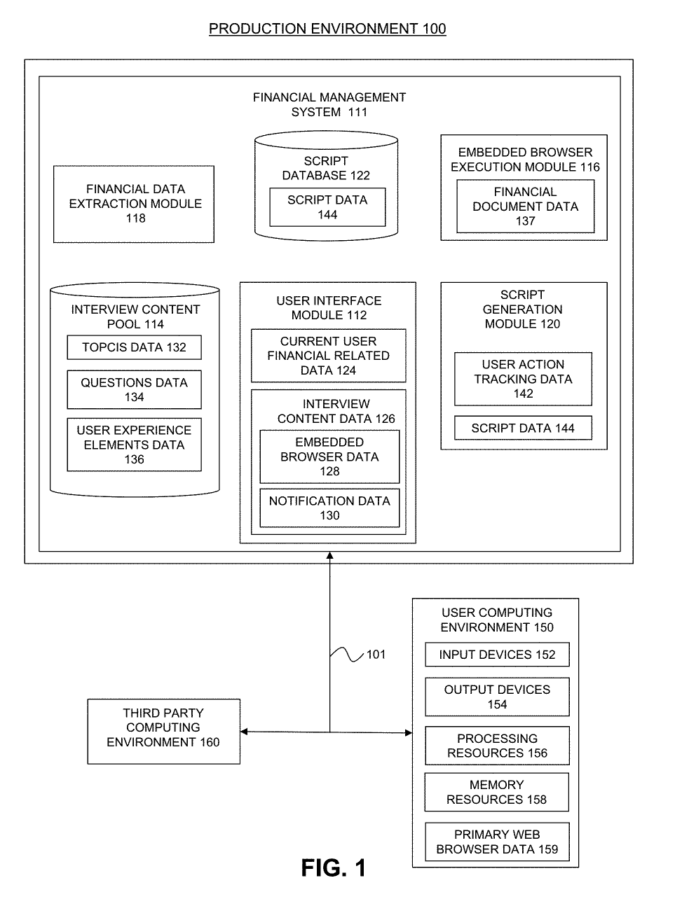

Hardware Architecture [ 0042 ] FIG. 1 illustrates a block diagram of a production environment 100 for facilitating the efficient and convenient retrieval of financial document data within a financial management interview, according to one embodiment. Embodiments of the present disclosure provide methods and systems for facilitating the efficient and convenient retrieval of financial document data within a financial management interview, according to one embodiment. A financial management system in accordance with embodiments of the present disclosure presents a financial management interview to a user via a primary web browser executed on the computing environment of the user. When the need arises for the user to retrieve financial document data from a third-party website in order to provide the financial document data to the financial management system as part of the financial management interview, the financial management system embeds a second web browser within the tab of the primary web browser that the user is currently using to receive the financial management interview. The embedded web browser assists the user to navigate to the third-party website and to retrieve the financial document data without switching to another tab or window of the primary web browser that the user is using to receive the financial management interview. The embedded web browser can download the financial document data from the third-party website directly to the financial management system via the embedded web browser. This enhances the efficiency of the financial management system and reduces the possibility of errors and mistakes that can occur when users need to switch between tabs or windows in a web browser in order to access third-party websites.

Additionally, embodiments of the present disclosure can automate the process of retrieving financial document data via the embedded web browser by tracking the steps taken by users to retrieve financial document data from various third-party websites. The financial management system generates user action tracking data for each type of financial document data for each third-party website that users access. When the financial management system has generated sufficient user action tracking data related to retrieving a particular kind of financial document data from a particular third-party website, the financial management system generates a script for automatically retrieving and downloading financial document data from third-party websites.

According to embodiments of the present disclosure, when a user of the financial management system needs to retrieve financial document data for which the financial management system has already generated a script, the financial management system opens an embedded web browser within the primary web browser and navigates to an authentication page of a third-party website from which the financial document data will be retrieved. The user can provide authentication data to sign into the third-party website via the embedded web browser. After the user has provided authentication data to sign into the third-party website via the embedded web browser, the financial management system executes the script and automatically downloads the financial document data to the financial management system via the embedded web browser.

Embodiments the present disclosure provide a technical solution to the technical problem of financial management systems that do not adequately facilitate and automate the process of retrieving and importing financial document data from third-party websites during a financial management interview. The technical solution includes generating an embedded web browser within the primary web browser that the user uses to receive the financial management interview and enabling retrieval of the financial document data via the embedded web browser without switching away from the web browser tab or window in which the user is receiving the financial management interview. The technical solution can further include generating script data based on the actions taken by previous users to retrieve financial document data via an embedded web browser. The technical solution can further include automatically downloading the financial document data by executing a script when the financial management system has previously generated a script for retrieving that particular kind of financial document data from that particular third-party website.

In addition, the disclosed method and system for facilitating the efficient and convenient retrieval of financial document data within a financial management interview provides for significant improvements to the technical fields of electronic financial management, electronic transaction data processing, data processing, data management, and user experience.

In addition, as discussed above, the disclosed method and system for facilitating the efficient and convenient retrieval of financial document data within a financial management interview provides for the processing and storing of smaller amounts of data, i.e., more efficiently collect financial data related to the user and providing a financial management interview to the user; thereby eliminating unnecessary data analysis and storage. Consequently, using the disclosed method and system for facilitating the efficient and convenient retrieval of financial document data within a financial management interview results in more efficient use of human and non-human resources, fewer processor cycles being utilized, reduced memory utilization, and less communications bandwidth being utilized to relay data to, and from, backend systems and client systems, and various investigative systems and parties. As a result, computing systems are transformed into faster, more efficient, and more effective computing systems by implementing the method and system for facilitating the efficient and convenient retrieval of financial document data within a financial management interview.

The production environment 100 includes a service provider computing environment 110, a user computing environment 150, and a third-party computing environment 160 for facilitating the efficient and convenient retrieval of financial document data within a financial management interview, according to various embodiments. The computing environments 110, 150, and 160 are communicatively coupled to each other with one or more networks 101, according to one embodiment. The networks 101 can include the Internet, one or more intranets, local area networks, wireless area networks, or other types of networks.

The service provider computing environment 110 represents one or more computing systems such as a server or a distribution center that is configured to receive, execute, and host one or more financial systems (e.g., applications) for access by one or more users, for facilitating the efficient and convenient retrieval of financial document data within a financial management interview, according to one embodiment. The service provider computing environment 110 represents a traditional data center computing environment, a virtual asset computing environment (e.g., a cloud computing environment), or a hybrid between a traditional data center computing environment and a virtual asset computing environment, according to one embodiment.

The service provider computing environment 110 includes a financial management system 111, which is configured to facilitate the efficient and convenient retrieval of financial document data within a financial management interview.

According to one embodiment, the financial management system 111 is a personal financial management system. More particularly, the financial management system 111 can be a tax return preparation system or a system that manages one or more of banking, investments, loans, credit cards, real estate investments, retirement planning, and budgeting. The financial management system 111 can be a standalone system that facilitates the efficient and convenient retrieval of financial document data within a financial management interview. Alternatively, the financial management system 111 can be integrated into other software or service products provided by a service provider.

The financial management system 111 presents a financial management interview to a user via a primary web browser executed on the user computing environment 150 associated with the user. When the need arises for the user to retrieve financial document data from a third-party website in order to provide the financial document data to the financial management system as part of the financial management interview, the financial management system 111 embeds a second web browser within the tab of the primary web browser that the user is currently using to receive the financial management interview. The embedded web browser facilitates retrieving the financial document data from the third-party website without causing the user to switch between tabs or windows in the web browser.

The financial management system 111 includes various components, databases, engines, modules, and/or data to support facilitating the efficient and convenient retrieval of financial document data within a financial management interview, according to various embodiment.

The financial management system 111 includes a user interface module 112, an interview content pool 114, an embedded browser execution module 116, a financial data extraction module 118, a script generation module 120, and a script database 122, according to various embodiments.

According to an embodiment, the user interface module 112 presents a financial management interview to the user by providing interview content data 126 to the user. The interview content data 126 guides a user through a series of financial topics, asks questions, and invites the user to provide data related to financial topics and questions. The user interface module 112 receives current user financial related data 124 in response to providing interview content data 126, according to one embodiment. The interview content data 126 includes embedded browser data 128 for facilitating the efficient and convenient retrieval of financial document data related to the user from third-party websites.

According to an embodiment, the user interface module 112 is configured to receive the current user financial related data 124 from the user or from other sources. The current user financial related data 124 includes information, such as, but not limited to, a name of the user, a name of the user's employer, an employer identification number (EID), a job title, annual income, salary and wages, bonuses, a Social Security number, a government identification, a driver's license number, a date of birth, an address, a zip code, home ownership status, marital status, W-2 income, an employer's address, spousal information, children's information, asset information, medical history, occupational information, information regarding dependents, salary and wages, interest income, dividend income, business income, farm income, capital gain income, pension income, IRA distributions, education expenses, health savings account deductions, moving expenses, IRA deductions, student loan interest, tuition and fees, medical and dental expenses, state and local taxes, real estate taxes, personal property tax, mortgage interest, charitable contributions, casualty and theft losses, unreimbursed employee expenses, alternative minimum tax, foreign tax credit, education tax credits, retirement savings contribution, child tax credits, residential energy credits, and any other information that is currently used, that can be used, or that may be used in the future, in a financial system or in the preparation of financial documents such as a user's tax return, according to various embodiments.

According to an embodiment, the user interface module 112 populates interview content data 126 from the interview content pool 114. The interview content pool 114 includes topics data 132, questions data 134, and user experience elements data 136. Each topic from the topics data 132 can be presented to the user with one or more questions from the questions data 134 and user experience elements from the user experience elements data 136, according to one embodiment. The user experience elements include, but are not limited to, buttons, slides, dialog boxes, text boxes, drop-down menus, banners, tabs, directory trees, links, audio content, video content, and/or other multimedia content for presenting topics and questions to the user and for receiving current user financial related data 124 from the user computing environment 150.

The user computing environment 150 includes input devices 152 and output devices 154 for communicating with the user, according to one embodiment. The input devices 152 include, but are not limited to, keyboards, mice, microphones, touchpads, touchscreens, digital pens, and the like. The output devices 154 include, but are not limited to, speakers, monitors, touchscreens, and the like.

The user computing environment 150 further includes processing resources 156 and the memory resources 158. The processing resources 156 can include one or more processors configured to execute operations in accordance with software instructions stored, for example, in the memory resources 158. The memory resources 158 can include one or more memories including computer readable media configured to store software instructions and other kinds of data that can be read and/or executed by the processing resources 156. The processing resources 156 and the memory resources 158 can together execute a primary web browser in accordance with primary web browser data 159.

In one embodiment, the user computing environment 150 interfaces with the user interface module 112 of the financial management system 111 via a primary web browser, in accordance with the primary web browser data 159. The user opens a tab in the primary web browser and navigates to a website associated with the financial management system 111 in order to receive a financial management interview. The user may begin the financial management interview by providing authentication data in order to sign into the financial management system 111. The financial management interview can include the presentation of one or more financial topics from the topics data 132 and questions from the questions data 134 requesting that the user provide current user financial related data 124 to the financial management system 111 via the primary web browser. In response to the current user financial related data 124, the financial management system 111 can select additional topics from the topics data 132 and questions from the questions data 134 to present to the user as part of the financial management interview process.

In one embodiment, the third-party computing environment 160 is associated with one or more third party websites. The financial management system 111 and the user computing environment can access third party websites by communicating with the third-party computing environment 160 via the network 101.

In one embodiment, as the financial management interview proceeds, the need may arise for the user to retrieve financial document data related to one or more financial documents of the user from the third-party website. The financial documents can include documents from a bank, documents from an employer, documents from a loan provider, documents from an investment manager, documents from a credit card company, documents from an educational institution, documents from a government institution, or other kinds of financial related documents. The financial management system 111 may determine that the user needs to obtain financial document data from a third-party website based on the current user financial related data 124. Additionally, or alternatively, the financial management system may ask the user if the user needs to retrieve financial document data from the third-party websites.

In typical traditional financial management systems, if the user needs to obtain financial document data from a third-party website, then the user would need to open a new tab or instance of the primary web browser in order to navigate to the third-party website. The user would then need to log into the third-party website to manually retrieve the financial document data. After the user downloads the financial document data from the third-party website, the user would then typically return to the tab of the web browser in which the user is receiving the financial management interview and manually enter data from the financial document data into the web browser. Oftentimes in such traditional financial management systems, users would accidentally enter a web address for the third-party website in the address bar of the tab in which the user is currently receiving the financial management interview, causing the user to mistakenly navigate away from the website of the financial management interview. If the user then attempts to return to the financial management interview, it is likely that the user will have to again log into the financial management system website. Furthermore, it is likely that the user will need to redo portions of the financial management interview that were not saved. This process can be frustrating, inconvenient, and inefficient.

The financial management system 111, in accordance with embodiments of the present disclosure overcomes the drawbacks of traditional financial management systems by utilizing an embedded browser execution module 116 to execute an embedded web browser within the current tab of the primary web browser from which the user is receiving the financial management interview. If, during the course of the financial management interview, it is determined that the user needs to retrieve financial document data from a third-party website, then the embedded browser execution module 116 executes an embedded web browser within the tab of the web browser in which the user is currently receiving the financial management interview. The current tab of the primary web browser remains at the website of the financial management system 111 while the financial management system 111 opens embedded web browser within the tab of the primary web browser. A portion of the current tab of the primary web browser becomes an embedded web browser that navigates to the website of the third-party from which the user will retrieve the financial document data 137. Thus, within the current tab of the primary web browser, the user sees both the website and the financial management system 111, and the third-party website from which the user for which he the financial document data 137. The financial management system 111 assists the user to retrieve the financial document data 137 from the third-party website via the embedded web browser within the current tab of the primary web browser.

In one embodiment, when the financial management system 111 opens the embedded web browser within the current tab of the primary web browser, the financial management system 111 opens the embedded web browser to an authentication page of the third-party website. The user can then enter the authentication data in order to sign into the third-party website. After the user has signed into the third-party website, the embedded web browser can assist the user to retrieve the financial document data 137.

In one embodiment, the user navigates via the embedded web browser to a webpage of the third-party website from which the user can select to download the financial document data 137. For example, after the user has provided the authentication data, the third-party website may display data that enables the user to navigate through various webpages of the third-party website. The user can select various links until the user identifies a link that enables the user to select to download the financial document data 137 from the third-party website. When the user selects to download the financial document data from the third-party website, the download of the financial document data 137 begins.

In one embodiment, when the user selects to download the financial document data 137 from the third-party website via the embedded web browser, the embedded browser execution module 116 causes the embedded web browser to download the financial document data 137 directly to the financial management system 111. Because the embedded web browser is implemented within the current tab of the primary web browser by the embedded browser execution module 116, the embedded browser execution module 116 is able to download the financial document data directly to the financial management system 111. Because the financial document data 137 is downloaded by the embedded web browser directly to the financial management system 111, the user does not need to undergo additional steps to upload the financial document data 137 to the financial management system 111. Additionally, the embedded web browser can cause the simultaneous download of the financial document data 137 to the user computing environment 150.

In one embodiment, the financial management system 111 utilizes the script generation module 120 to generate an automated script that enables the embedded web browser to automatically download financial document data 137 for users of the financial management system 111. As various users of the financial management system 111 utilizes the embedded web browser to navigate through various third-party websites in order to download financial document data 137 from the third-party websites, the embedded browser execution module 116 tracks the actions and selections made by the users. The script generation module 120 stores user action tracking data 142 that includes a record of the actions taken by the users of the financial management system 111 as they navigate through the third-party websites to retrieve financial document data 137. The script generation module 120 analyzes the user action tracking data 140 to generate script data 144. The script data 144 defines one or more automated scripts that enable the embedded web browser to automatically retrieve financial document data 137 from the third-party websites.

In one embodiment, the script data 144 includes a plurality of separate scripts, each for retrieving a particular kind of financial document data 137 from a particular third-party website. Within a single third-party website, there may be multiple kinds of financial document data 137 that can be retrieved. The steps for retrieving each kind of financial document data 137 from the third-party website may vary, even if only slightly. Thus, a separate script is needed for each kind of financial document data 137. Furthermore, the steps needed to retrieve financial document data 137 from various different third-party websites are also different from each other. Thus, the script data 144 includes a separate script for retrieving as many types of financial document data 137 from as many third-party websites as the script generation module 120 is able to generate based on the actions of the users of the financial management system 111. The script generation module 120 may need to record user action tracking data 142 for dozens or hundreds of users that have retrieved a particular kind of financial document data 137 from a particular third-party website in order to generate an accurate script for retrieving the particular kind of financial document data 137 from the particular third-party website.

In one embodiment, the financial management system 111 utilizes a script database 122 to store the various scripts that have been generated so far by the financial management system 111. The script database 122 stores the script data 144 that was previously generated by the script generation module 120. When the financial management system 111 needs to execute an automated script to retrieve financial document data 137 for a user from a third-party website via the embedded web browser, the financial management system 111 can check the script data 144 of the script database 122 in order to determine whether or not a valid script is available for automatically retrieving the financial document data 137. If a valid script is present in the script data 144 for retrieving that financial document data 137, then the financial management system 111 can open the embedded web browser to the third-party website and can execute the script for automatically retrieving the desired financial document data 137.

In one embodiment, when a user is receiving a financial management interview in a current tab of a primary web browser executed in the user computing environment 150 to interface with the financial management system 111, the financial management system 111 may determine that the user needs to retrieve a particular kind of financial document data 137 from a particular third-party website. The financial management system 111 may determine that the script exists for retrieving the particular kind of financial document data 137 from the particular third-party website. The embedded browser execution module 116 opens an embedded web browser to an authentication page of the third-party website. The financial management system 111 may display a message in the portion of the current tab of the primary web browser that is separate from the embedded web browser prompting the user to sign into the third-party website. After the user has provided authentication data and signed into the third-party website, the embedded browser execution module 116 executes the script for automatically retrieving the financial document data 137. The embedded browser execution module 116 downloads the financial document data 137 to the financial management system 111.

In one embodiment, as third-parties adjust their websites, scripts that previously functioned properly may no longer function properly because the third-party websites are no longer the same. Accordingly, if the embedded browser execution module 116 determines that a script from the script data 144 no longer properly works to download the financial document data 137 for which it is designed, the embedded browser execution module 116 can begin the process of repairing the script. In particular, the embedded browser execution module 116 opens embedded web browsers within the current tabs of various primary browsers of users of the financial management system 111 and prompts the users to navigate through the third-party websites in order to download the financial document data 137. The embedded browser execution module 116 records user action tracking data 142 that includes the actions taken by the users in the embedded web browser to obtain the particular kind of financial document data 137. The embedded browser execution module 116 provides the user action tracking data 142 to the script generation module 120. The script generation module 120 analyzes the user action tracking data 142 to determine how the script needs to be adjusted in order to match the actions taken by users to retrieve financial document data 137 from the adjusted third-party website. The script generation module 120 generates a new script based on the user action tracking data 142. The financial management system 111 can then execute the script for subsequent users of the financial management system 111.

In one embodiment, the financial management system 111 utilizes the financial data extraction module 118 to automatically extract data from the financial document data 137 into data fields of one or more financial forms to be filled out as part of the financial management interview process. After the embedded browser execution module 116 has downloaded the financial document data 137 from the third-party website via the embedded web browser, the financial data extraction module 118 analyzes the financial document data 137 in order to extract selected data values from the financial document data 137 for importation into an electronic financial document being prepared by the financial management system 111. The financial data extraction module 118 can analyze the financial document data 137 in accordance with one or more analytic techniques in order to extract the desired information from the financial document data 137. In this way, the financial management system 111 further improves the efficiency of the financial management interview by automatically retrieving the financial document data 137 and by automatically importing data from the financial document data 137 into an electronic version of the financial form being prepared by the financial management system 111 as part of the financial management interview.

In one embodiment, the financial management system 111 presents notification data 130 to the user in the web browser related to actions being taken in the embedded web browser. The financial management system 111 presents the notification data in that portion of the current tab of the primary web browser through which the financial management interview is presented to the user. The notification data 130 is generated by the embedded browser execution module 116 and presented to the user with the interview content data 126.

In one embodiment, the notification data 130 can include a notification that a download of the financial document data 137 has been initiated. Thus, when download of the financial document data 137 is initiated via the embedded web browser by either the user or an automated script, the financial management system 111 presents notification data 130 that includes a notification that download of the financial document data 137 has been initiated.

In one embodiment, the notification data 130 can include a notification related to the progress of the download of the financial document data 137. The notification data 130 can provide an indication of a percentage of the financial document data 137 that has been downloaded. Additionally, or alternatively, the notification data 130 can provide an indication of a rate at which the financial document data 137 is being downloaded.

The notification data 130 can include a notification that the download of the financial document data 137 has been completed successfully. Thus, once the embedded browser execution module 116 has successfully downloaded the financial document data 137 to the financial management system 111, the user interface module 112 can output notification data 130 informing the user that the financial document data 137 has been successfully downloaded.

In one embodiment, the notification data 130 can include a notification that the download of the financial document data has failed. In some cases, failure to download the financial document data can occur because of user error. In other cases, failure to download the financial document data 137 can occur due to an error in the script data 144. In some cases, failure to download the financial document data 137 can occur due to an interrupted Internet connection or due to a failure on the part of the third-party website. The notification data 130 can also include an indication as to why the download of the financial document data 137 was not completed successfully by the embedded browser execution module 116.

In one embodiment, the notification data 130 can include a notification that the financial document data 130 selected by the user, or by the script, is not the correct financial document data. In some cases, the user may accidentally select the incorrect financial document data 137 for download from the third-party website. The embedded browser execution module 116 and/or the financial data extraction module 118 can analyze the financial document data 137 and can determine that the financial document data 137 is not the correct financial document data needed for the financial management interview.

In one embodiment, the financial management system 111 is a tax return preparation system. In this case, the financial management interview is a tax return preparation interview to electronically prepare a tax return of the user. The user connects to a website associated with the tax return preparation system using a primary web browser executed by the user computing environment 150. After the user connects to the website associated with the tax return preparation system, the tax return preparation system initiates a tax return preparation interview with the user.

In one embodiment, once the tax return preparation system has initiated a tax return preparation interview with the user, the tax return preparation system presents the tax related topics with tax related questions prompting the user to provide current user tax related data to the tax return preparation system. The user provides current user tax related data to the tax return preparation system in response to the topics and questions presented by the tax return preparation system. The current user tax related data may include data values or tax documents provided by the user to the tax return preparation system.

In one embodiment, based on the current user tax related data provided by the user to the tax return preparation system via the current tab of the primary web browser, the tax return preparation system may determine that there is a need to retrieve tax related document data corresponding to an electronic version of the tax form from a third-party website. For example, the current user tax related data provided by the user may indicate that the user has a contractual relationship with a third-party business. The tax return preparation system may determine that the user needs to provide data from a form 1099 to the tax return preparation system. The tax return preparation system may invite the user to log into a website associated with the third-party business in order to download tax related document data including form 1099 from the third-party website. The tax return preparation system initiates an embedded web browser within the current tab of the primary web browser. The embedded web browser is opened to a website of the third-party business. Thus, within the current tab of the primary browser the user sees the website of the tax return preparation system through which the tax return preparation interviews been provided as well as the website of the third-party business via the embedded web browser.

In one embodiment, the user provides authentication data to the third-party website via the embedded web browser. If the tax return preparation system does not have a script for automatically obtaining the 1099 form from the third-party website, then the tax return preparation system presents notification data inviting the user to navigate to the form 1099 download page on the third-party website and to initiate the download of the users form 1099 from the third-party website. The embedded web browser downloads the form 1099 automatically to the tax return preparation system.

In one embodiment, while the user navigates to the form 1099 download page on the third-party website, the embedded browser execution module 116 generates user action tracking data 142 and provides it to the script generation module 120. The user action tracking data 142 tracks the steps taken by the user to locate the form 1099 on the third-party website and to initiate download of the form 1099. Based on the user action tracking data from the user, as well as from other users of the tax return preparation system, the script generation module 120 generates script data 144 corresponding to a script for automatically downloading the form 1099 data from that particular third-party website.

In one embodiment, the tax return preparation system already has a script for downloading the form 1099 data from the third-party website. After the user provides authentication data via, the embedded browser execution module 116 executes the script for automatically downloading the form 1099 from the third-party website. Using the script, the tax return preparation system automatically downloads the form 1099 for the user from the third-party website.

In one embodiment, the user can first provide authentication data for the third-party website to the tax return preparation system. The tax return preparation system can then communicate with the third-party website to authenticate the user. After the user has been authenticated, the tax return preparation system can execute the script to automatically download the form 1099. Alternatively, the user can provide authentication data via the embedded web browser.

In one embodiment, the tax return preparation system presents notification data 130 to the user via the website of the tax return preparation system. The notification data 130 can include an invitation to log into the third-party website. The notification data 130 can include an indication that the tax return preparation system is downloading the tax related document data. The notification data 130 can include an indication of progress of the download of the tax related document data. The notification data 130 can include an indication that the tax related document data has been successfully downloaded. The notification data 130 can include an indication that the download of the tax related document data has failed. The notification data 130 can include an indication of which tax related documents having downloaded. The notification data 130 can include an invitation to download additional tax related documents from the third-party website or from other third-party websites.

In one embodiment, principles of the present disclosure include a situation in a financial management interview is provided through a software application other than a primary web browser. In these cases, the financial management system 111 embeds the embedded web browser within the software application rather than within a primary web browser.

In one embodiment, principles of the present disclosure can extend to systems other than financial management systems. Principles of the present disclosure can extend to any situation in which a user may need to access a third-party website to retrieve data for a website to which the user is already connected in a webpage of the web browser.

### Process

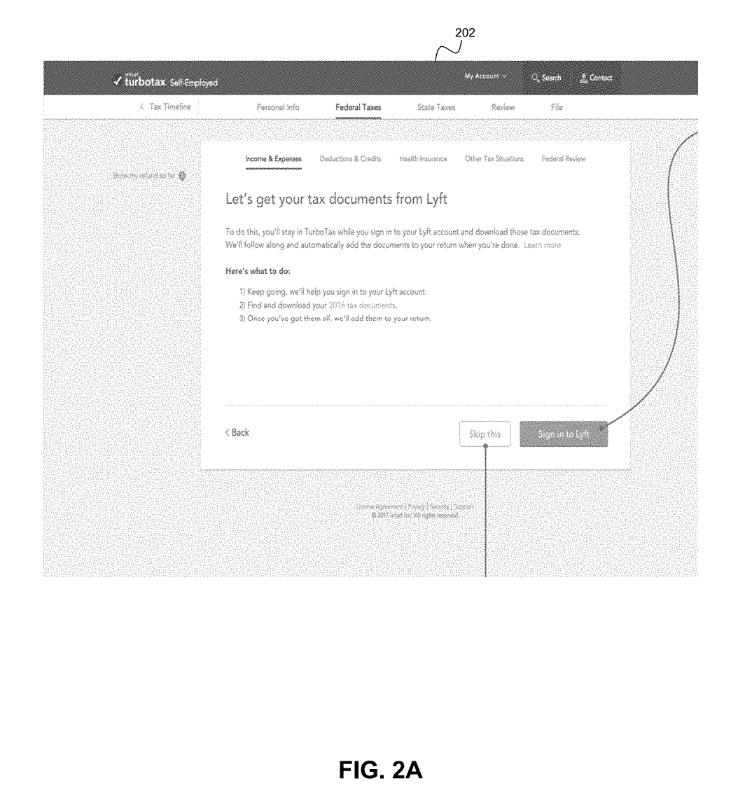

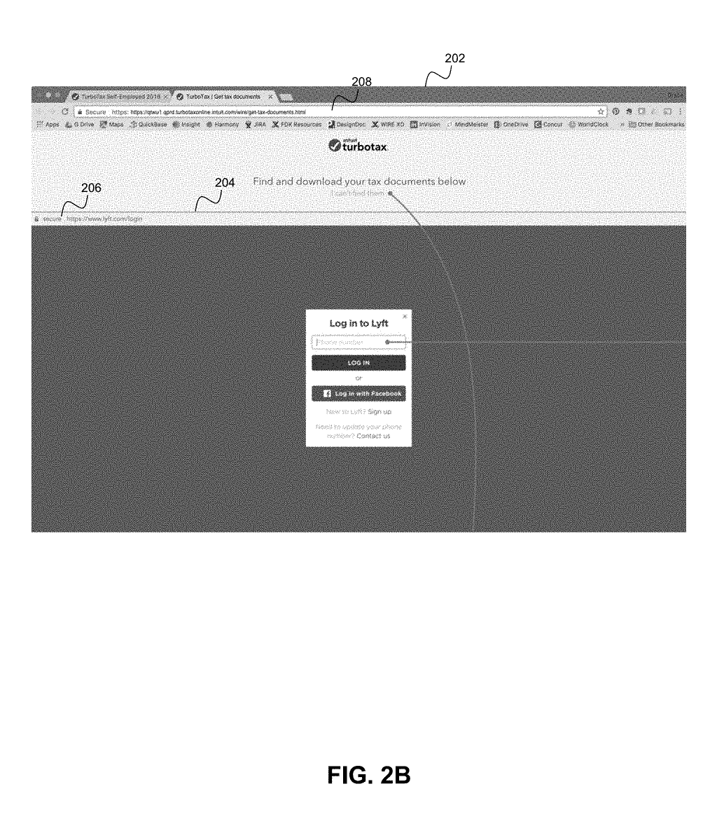

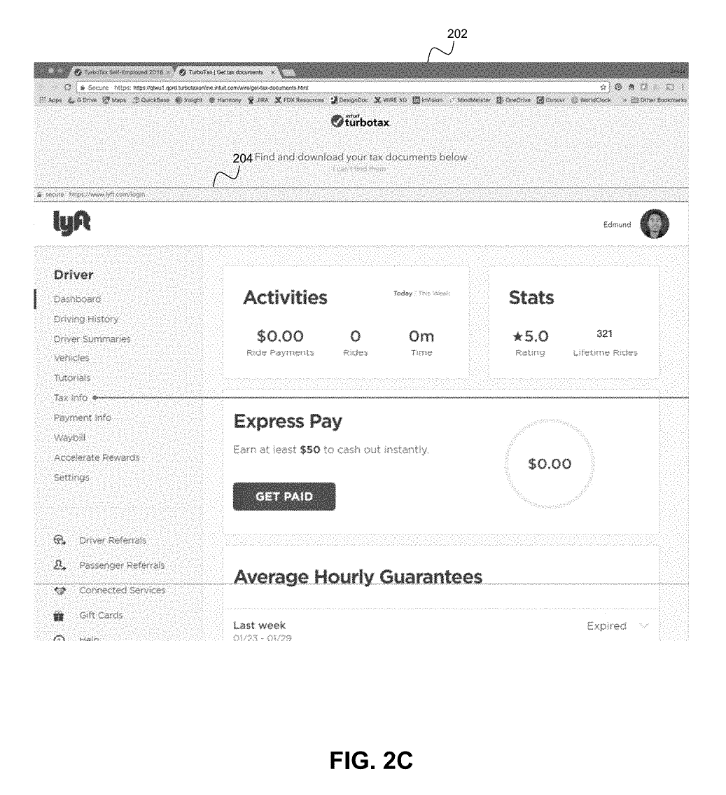

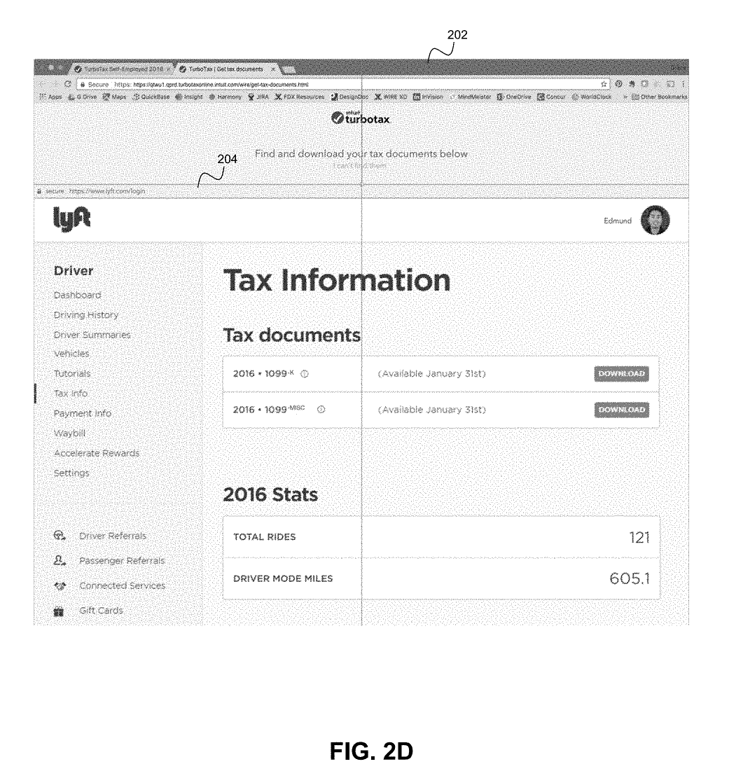

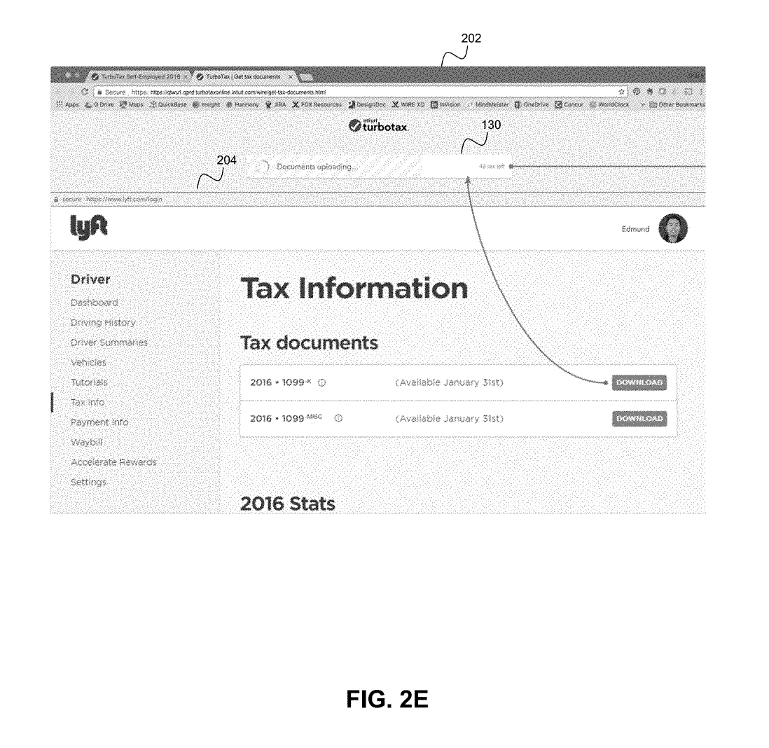

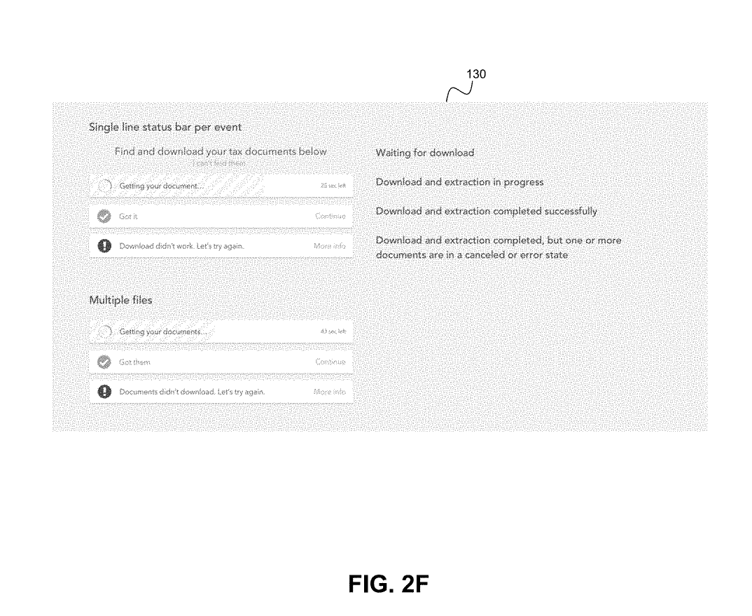

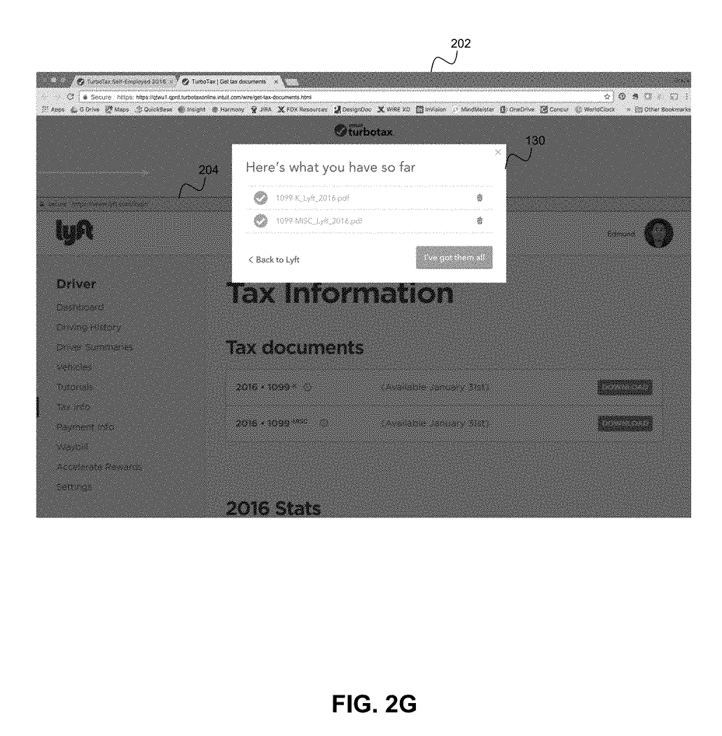

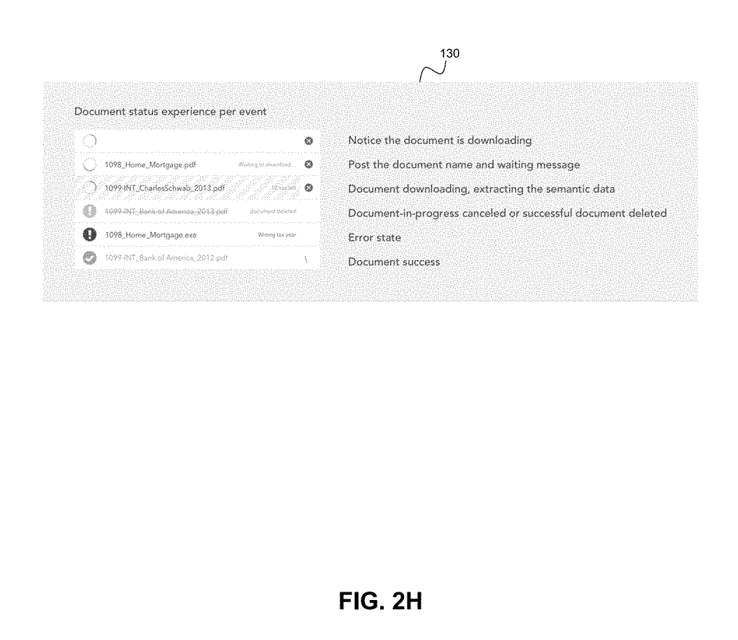

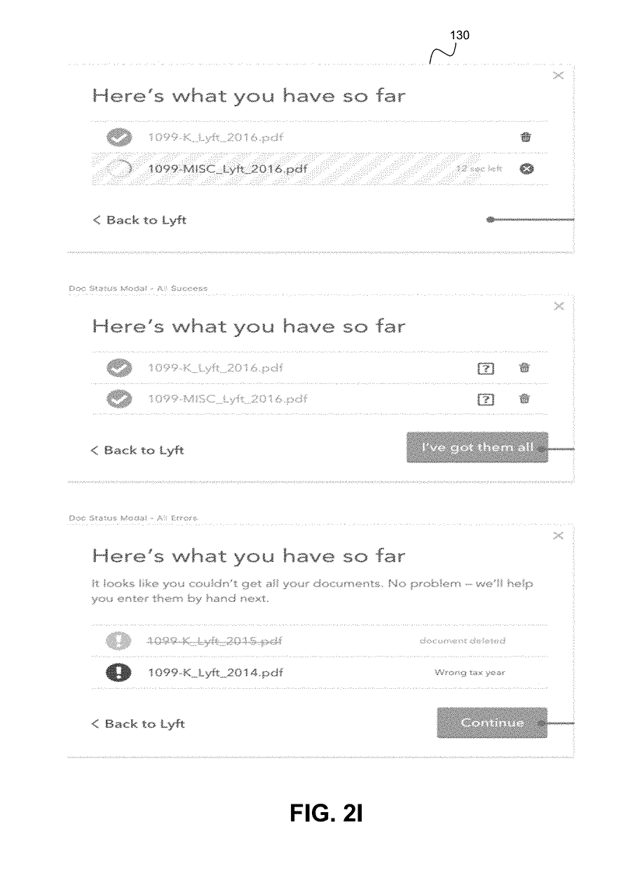

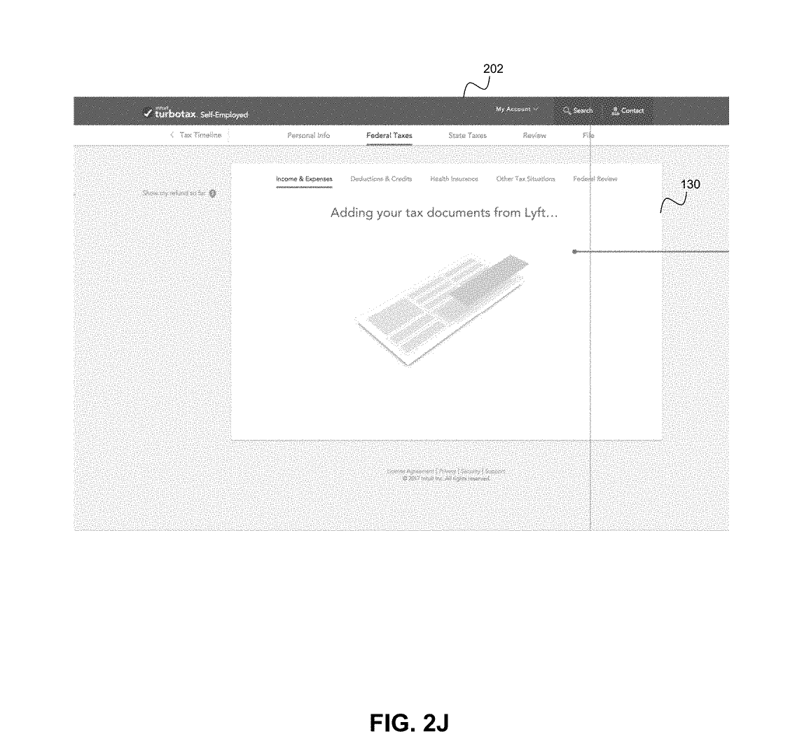

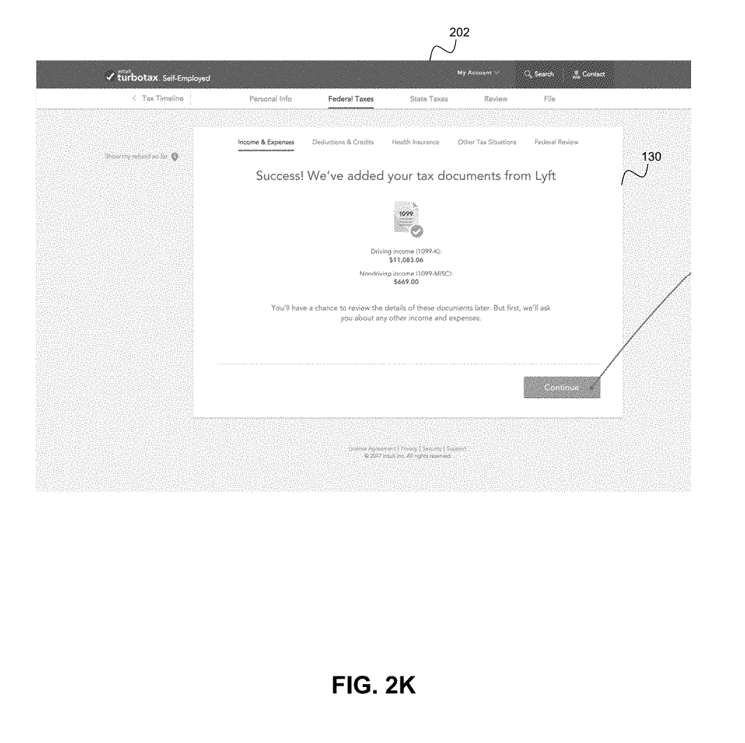

FIGS. 2A-2K are illustrations of financial management interview content presented in a primary browser 202 of a user computing environment by a financial management system 111, according to various embodiments. In the examples shown in FIG. 2A-2K, the financial management system 111 is a tax return preparation system that assists a user to obtain tax related documents from the website of a third-party business.

FIG. 2A shows the primary web browser 202 displaying tax return preparation interview content data to a user. The tax return preparation interview content data recommends obtaining tax related document data from a third-party business with how the user has a contractual relationship.

In FIG. 2B the tax return preparation system has opened an embedded web browser 204 within the primary web browser 202. The tab of the primary browser displays content from an authentication or sign in page of the website associated with the tax return preparation system as well the third-party website via the embedded browser 204. The URL address of the third-party website is displayed in the address bar 206 of the embedded web browser. The URL associated with tax return preparation system is displayed in the address bar 208 of the tab of the primary web browser 202. The interview content data prompts the user to retrieve tax related document data from third-party website via the embedded web browser 204.

In FIG. 2C the embedded web browser 204 displays the third-party website after the user has signed in, including many options for navigating throughout the third-party website.

In FIG. 2D the user has navigated to a web page within the third-party website that includes links to download tax related document data of the user via the embedded web browser 204.

In FIG. 2E the user has selected to download tax related document data from the third-party website via the embedded browser. The primary browser 202 displays notification data 130 indicating the progress of the download.

FIG. 2F illustrates various kinds of notification data 130 that can be displayed in the primary browser. The notification data 130 includes notifications, for individual and multiple documents, that the tax return preparation system is downloading the tax related document data, that the tax return preparation system has completed the download, and that the tax return preparation system could not complete the download.

In FIG. 2G, the notification data 130 indicates which tax related document data has been downloaded so far.

FIG. 2H illustrates various kinds of notification that can be included in the notification data 130, including notification related to the download of the tax related document data and the extraction of data from the tax related document data.

FIG. 2I illustrates various kinds of notification that can be included in the notification data 130.

In FIG. 2J primary browser 202 displays notification data 130 indicating that the tax related document data is being imported into the tax return preparation system.

In FIG. 2K primary browser 202 displays notification data 130 indicating that the data from the tax related document data has been imported into the tax return preparation system.

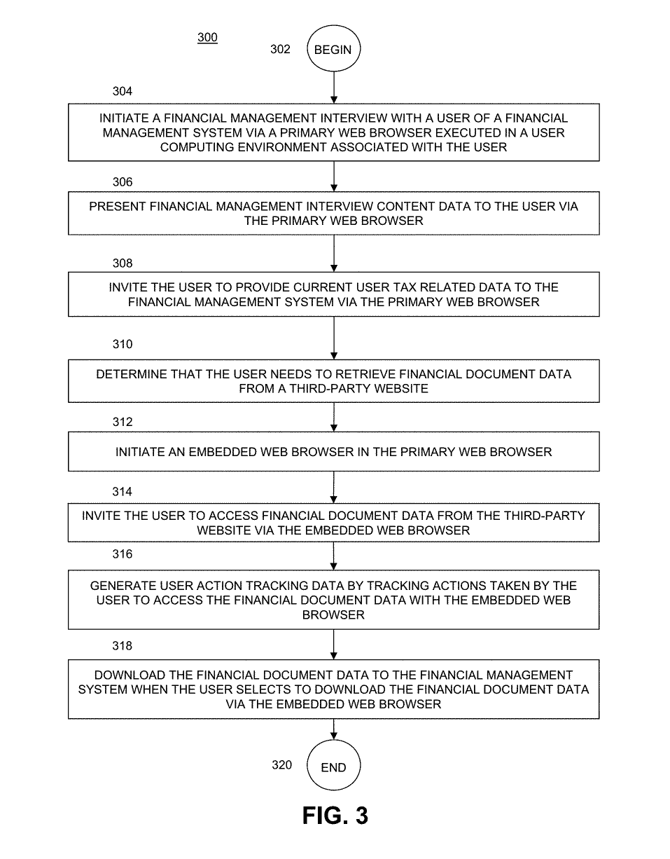

FIG. 3 illustrates a flow diagram of a process 300 for facilitating the efficient and convenient retrieval of financial document data within a financial management interview, according to various embodiments.

In one embodiment, process 300 begins at BEGIN 302 and process flow proceeds to INITIATE A FINANCIAL MANAGEMENT INTERVIEW WITH A USER OF A FINANCIAL MANAGEMENT SYSTEM VIA A PRIMARY WEB BROWSER EXECUTED IN A USER COMPUTING ENVIRONMENT ASSOCIATED WITH THE USER 304.

In one embodiment, at INITIATE A FINANCIAL MANAGEMENT INTERVIEW WITH A USER OF A FINANCIAL MANAGEMENT SYSTEM VIA A PRIMARY WEB BROWSER EXECUTED IN A USER COMPUTING ENVIRONMENT ASSOCIATED WITH THE USER 304 process 300 initiates a financial management interview with a user of a financial management system via a primary web browser executed in a user computing environment associated with the user.

In one embodiment, once a financial management interview is initiated with a user of a financial management system via a primary web browser executed in a user computing environment associated with the user at INITIATE A FINANCIAL MANAGEMENT INTERVIEW WITH A USER OF A FINANCIAL MANAGEMENT SYSTEM VIA A PRIMARY WEB BROWSER EXECUTED IN A USER COMPUTING ENVIRONMENT ASSOCIATED WITH THE USER 304 process flow proceeds to PRESENT FINANCIAL MANAGEMENT INTERVIEW CONTENT DATA TO THE USER VIA THE PRIMARY WEB BROWSER 306.

In one embodiment, at PRESENT FINANCIAL MANAGEMENT INTERVIEW CONTENT DATA TO THE USER VIA THE PRIMARY WEB BROWSER 306, process 300 presents financial management interview content data to the user via the primary web browser.

In one embodiment, once financial management interview content data is presented to the user via the primary web browser at PRESENT FINANCIAL MANAGEMENT INTERVIEW CONTENT DATA TO THE USER VIA THE PRIMARY WEB BROWSER 306, process flow proceeds to INVITE THE USER TO PROVIDE CURRENT USER TAX RELATED DATA TO THE FINANCIAL MANAGEMENT SYSTEM VIA THE PRIMARY WEB BROWSER 308.

In one embodiment, at INVITE THE USER TO PROVIDE CURRENT USER TAX RELATED DATA TO THE FINANCIAL MANAGEMENT SYSTEM VIA THE PRIMARY WEB BROWSER 308, process 300 invites the user to provide current user tax related data to the financial management system via the primary web browser.

In one embodiment, once the user is invited to provide current user tax related data to the financial management system via the primary web browser at INVITE THE USER TO PROVIDE CURRENT USER TAX RELATED DATA TO THE FINANCIAL MANAGEMENT SYSTEM VIA THE PRIMARY WEB BROWSER 308, process flow proceeds to DETERMINE THAT THE USER NEEDS TO RETRIEVE FINANCIAL DOCUMENT DATA FROM A THIRD-PARTY WEBSITE 310.

In one embodiment, at DETERMINE THAT THE USER NEEDS TO RETRIEVE FINANCIAL DOCUMENT DATA FROM A THIRD-PARTY WEBSITE 310 process 300 determines that the user needs to retrieve financial document data from a third-party website.

In one embodiment, once it is determined that the user needs to retrieve financial document data from a third-party website at DETERMINE THAT THE USER NEEDS TO RETRIEVE FINANCIAL DOCUMENT DATA FROM A THIRD-PARTY WEBSITE 310 process flow proceeds to INITIATE AN EMBEDDED WEB BROWSER IN THE PRIMARY WEB BROWSER 312.

In one embodiment, at INITIATE AN EMBEDDED WEB BROWSER IN THE PRIMARY WEB BROWSER 312 the process 300 initiates an embedded web browser in the primary web browser.

In one embodiment, an embedded web browser is initiated in the primary web browser at INITIATE AN EMBEDDED WEB BROWSER IN THE PRIMARY WEB BROWSER 312, process flow proceeds to INVITE THE USER TO ACCESS FINANCIAL DOCUMENT DATA FROM THE THIRD-PARTY WEBSITE VIA THE EMBEDDED WEB BROWSER 314.

In one embodiment, at INVITE THE USER TO ACCESS FINANCIAL DOCUMENT DATA FROM THE THIRD-PARTY WEBSITE VIA THE EMBEDDED WEB BROWSER 314 process 300 invites the user to access financial document data from the third-party website via the embedded web browser.

In one embodiment, once the user is invited to access financial document data from the third-party website via the embedded web browser at INVITE THE USER TO ACCESS FINANCIAL DOCUMENT DATA FROM THE THIRD-PARTY WEBSITE VIA THE EMBEDDED WEB BROWSER 314, process flow proceeds to GENERATE USER ACTION TRACKING DATA BY TRACKING ACTIONS TAKEN BY THE USER TO ACCESS THE FINANCIAL DOCUMENT DATA WITH THE EMBEDDED WEB BROWSER 316.

In one embodiment, at GENERATE USER ACTION TRACKING DATA BY TRACKING ACTIONS TAKEN BY THE USER TO ACCESS THE FINANCIAL DOCUMENT DATA WITH THE EMBEDDED WEB BROWSER 316 process 300 generates user action tracking data by tracking actions taken by the user to access the financial document data with the embedded web browser.

In one embodiment, user action tracking data is generated by tracking actions taken by the user to access the financial document data with the embedded web browser at GENERATE USER ACTION TRACKING DATA BY TRACKING ACTIONS TAKEN BY THE USER TO ACCESS THE FINANCIAL DOCUMENT DATA WITH THE EMBEDDED WEB BROWSER 316, process flow proceeds to DOWNLOAD THE FINANCIAL DOCUMENT DATA TO THE FINANCIAL MANAGEMENT SYSTEM WHEN THE USER SELECTS TO DOWNLOAD THE FINANCIAL DOCUMENT DATA VIA THE EMBEDDED WEB BROWSER 318.

In one embodiment, at DOWNLOAD THE FINANCIAL DOCUMENT DATA TO THE FINANCIAL MANAGEMENT SYSTEM WHEN THE USER SELECTS TO DOWNLOAD THE FINANCIAL DOCUMENT DATA VIA THE EMBEDDED WEB BROWSER 318 process 300 downloads the financial document data to the financial management system when the user selects to download the financial document data via the embedded web browser.

In one embodiment, once the financial document data is downloaded to the financial management system when the user selects to download the financial document data via the embedded web browser at DOWNLOAD THE FINANCIAL DOCUMENT DATA TO THE FINANCIAL MANAGEMENT SYSTEM WHEN THE USER SELECTS TO DOWNLOAD THE FINANCIAL DOCUMENT DATA VIA THE EMBEDDED WEB BROWSER 318, process flow proceeds to END 320.

In one embodiment, at END 320 the process for facilitating the efficient and convenient retrieval of financial document data within a financial management interview is exited to await new data and/or instructions.

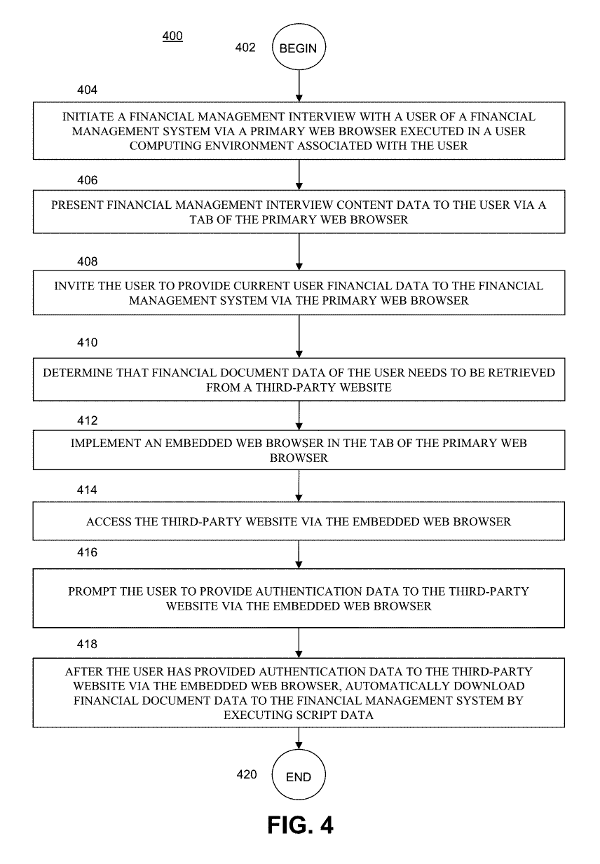

FIG. 4 illustrates a flow diagram of a process 400 for facilitating the efficient and convenient retrieval of financial document data within a financial management interview, according to various embodiments.

In one embodiment, process 400 begins at BEGIN 402 and process flow proceeds to INITIATE A FINANCIAL MANAGEMENT INTERVIEW WITH A USER OF A FINANCIAL MANAGEMENT SYSTEM VIA A PRIMARY WEB BROWSER EXECUTED IN A USER COMPUTING ENVIRONMENT ASSOCIATED WITH THE USER 404.

In one embodiment, at INITIATE A FINANCIAL MANAGEMENT INTERVIEW WITH A USER OF A FINANCIAL MANAGEMENT SYSTEM VIA A PRIMARY WEB BROWSER EXECUTED IN A USER COMPUTING ENVIRONMENT ASSOCIATED WITH THE USER 404 process 400 initiates a financial management interview with a user of a financial management system via a primary web browser executed in a user computing environment associated with the user.

In one embodiment, once a financial management interview is initiated with a user of a financial management system via a primary web browser executed in a user computing environment associated with the user at INITIATE A FINANCIAL MANAGEMENT INTERVIEW WITH A USER OF A FINANCIAL MANAGEMENT SYSTEM VIA A PRIMARY WEB BROWSER EXECUTED IN A USER COMPUTING ENVIRONMENT ASSOCIATED WITH THE USER 404 process flow proceeds to PRESENT FINANCIAL MANAGEMENT INTERVIEW CONTENT DATA TO THE USER VIA A TAB OF THE PRIMARY WEB BROWSER 406.

In one embodiment, at PRESENT FINANCIAL MANAGEMENT INTERVIEW CONTENT DATA TO THE USER VIA A TAB OF THE PRIMARY WEB BROWSER 406, process 400 presents financial management content data to the user via a tab of the primary web browser.

In one embodiment, once financial management interview content data is presented to the user via a tab of the primary web browser at PRESENT FINANCIAL MANAGMENT INTERVIEW CONTENT DATA TO THE USER VIA A TAB OF THE PRIMARY WEB BROWSER 406, process flow proceeds to INVITE THE USER TO PROVIDE CURRENT USER FINANCIAL DATA TO THE FINANCIAL MANAGEMENT SYSTEM VIA THE PRIMARY WEB BROWSER 408.

In one embodiment, at INVITE THE USER TO PROVIDE CURRENT USER FINANCIAL DATA TO THE FINANCIAL MANAGEMENT SYSTEM VIA THE PRIMARY WEB BROWSER 408, process 400 invites the user to provide current user financial data to the financial management system via the primary web browser.

In one embodiment, once the user is invited to provide current user financial data to the financial management system via the primary web browser at INVITE THE USER TO PROVIDE CURRENT USER FINANCIAL DATA TO THE FINANCIAL MANAGEMENT SYSTEM VIA THE PRIMARY WEB BROWSER 408, process flow proceeds to DETERMINE THAT FINANCIAL DOCUMENT DATA OF THE USER NEEDS TO BE RETRIEVED FROM A THIRD-PARTY WEBSITE 410.

In one embodiment, at DETERMINE THAT FINANCIAL DOCUMENT DATA OF THE USER NEEDS TO BE RETRIEVED FROM A THIRD-PARTY WEBSITE 410 the process 400 determines that financial document data of the user needs to be retrieved from a third-party website.

In one embodiment, once process 400 it is determined that financial document data of the user needs to be retrieved from a third-party website at DETERMINE THAT FINANCIAL DOCUMENT DATA OF THE USER NEEDS TO BE RETRIEVED FROM A THIRD-PARTY WEBSITE 410 process flow proceeds to IMPLEMENT AN EMBEDDED WEB BROWSER IN THE TAB OF THE PRIMARY WEB BROWSER 412.

In one embodiment, at IMPLEMENT AN EMBEDDED WEB BROWSER IN THE TAB OF THE PRIMARY WEB BROWSER 412 the process 400 implements an embedded web browser in the tab of the primary web browser.

In one embodiment, once an embedded web browser is implemented in the tab of the primary web browser at IMPLEMENT AN EMBEDDED WEB BROWSER IN THE TAB OF THE PRIMARY WEB BROWSER 412, process flow proceeds to ACCESS THE THIRD-PARTY WEBSITE VIA THE EMBEDDED WEB BROWSER 414.

In one embodiment, at ACCESS THE THIRD-PARTY WEBSITE VIA THE EMBEDDED WEB BROWSER 414 the process 400 accesses the third-party website via the embedded web browser.

In one embodiment, once the third-party website is accessed via the embedded web browser at ACCESS THE THIRD-PARTY WEBSITE VIA THE EMBEDDED WEB BROWSER 414, process flow proceeds to PROMPT THE USER TO PROVIDE AUTHENTICATION DATA TO THE THIRD-PARTY WEBSITE VIA THE EMBEDDED WEB BROWSER 416.

In one embodiment, at PROMPT THE USER TO PROVIDE AUTHENTICATION DATA TO THE THIRD-PARTY WEBSITE VIA THE EMBEDDED WEB BROWSER 416 the process 400 prompts the user to provide authentication data to the third-party website via the embedded web browser.

In one embodiment, once the user is prompted to provide authentication data to the third-party website via the embedded web browser at PROMPT THE USER TO PROVIDE AUTHENTICATION DATA TO THE THIRD-PARTY WEBSITE VIA THE EMBEDDED WEB BROWSER 416, process flow proceeds to AFTER THE USER HAS PROVIDED AUTHENTICATION DATA TO THE THIRD-PARTY WEBSITE VIA THE EMBEDDED WEB BROWSER, AUTOMATICALLY DOWNLOAD THE FINANCIAL DOCUMENT DATA TO THE FINANCIAL MANAGEMENT SYSTEM BY EXECUTING SCRIPT DATA 418.

In one embodiment, at AFTER THE USER HAS PROVIDED AUTHENTICATION DATA TO THE THIRD-PARTY WEBSITE VIA THE EMBEDDED WEB BROWSER, AUTOMATICALLY DOWNLOAD THE FINANCIAL DOCUMENT DATA TO THE FINANCIAL MANAGEMENT SYSTEM BY EXECUTING SCRIPT DATA 418 process 400 automatically downloads the financial document data to the financial management system by executing script data after the user has provided authentication data to the third-party website via the embedded web browser.

In one embodiment, once the financial document data is automatically downloaded to the financial management system by executing the script data after the user has provided authentication data to the third-party website via the embedded web browser at AFTER THE USER HAS PROVIDED AUTHENTICATION DATA TO THE THIRD-PARTY WEBSITE VIA THE EMBEDDED WEB BROWSER, AUTOMATICALLY DOWNLOAD THE FINANCIAL DOCUMENT DATA TO THE FINANCIAL MANAGEMENT SYSTEM BY EXECUTING SCRIPT DATA 418, process flow proceeds to END 420.

In one embodiment, at END 420 the process for facilitating the efficient and convenient retrieval of financial document data within a financial management interview is exited to await new data and/or instructions.

As noted above, the specific illustrative examples discussed above are but illustrative examples of implementations of embodiments of the method or process for providing a tax refund confidence indicator to a user. Those of skill in the art will readily recognize that other implementations and embodiments are possible. Therefore, the discussion above should not be construed as a limitation on the claims provided below.

In one embodiment, a system facilitates the efficient and convenient retrieval of financial document data within a financial management interview. The system includes at least one processor at least one memory coupled to the at least one processor. The at least one memory has stored therein instructions which, when executed by any set of the one or more processors, perform a process. The process includes initiating a tax return preparation interview with a user of a tax return preparation system via a primary web browser executed in a user computing environment associated with the user and presenting tax return preparation interview content data to the user via the primary web browser. The process includes inviting the user to provide current user tax related data to the tax return preparation system via the primary web browser and determining that the user needs to retrieve tax related document data from a third-party website. The process includes initiating an embedded web browser in the primary web browser and inviting the user to access tax related document data from the third-party website via the embedded web browser. The process includes generating user action tracking data by tracking actions taken by the user to access the tax related document data with the embedded web browser and downloading the tax related document data to the tax return preparation system when the user selects to download the tax related document data via the embedded web browser.

In one embodiment, a computing system implemented method facilitates the efficient and convenient retrieval of financial document data within a financial management interview. The method includes initiating a financial management interview with a user of a financial management system via a primary web browser executed in a user computing environment associated with the user and presenting financial management interview content data to the user via a tab of the primary web browser. The method includes inviting the user to provide current user financial data to the financial management system via the primary web browser and determining that financial document data of the user needs to be retrieved from a third-party website. The method includes implementing an embedded web browser in the tab of the primary web browser and accessing the third-party website via the embedded web browser. The method includes prompting the user to provide authentication data to the third-party website via the embedded web browser and, after the user has provided authentication data to the third-party website via the embedded web browser, automatically downloading the tax related document data to the tax return preparation system by executing script data.

In one embodiment, a non-transitory computer-readable medium has a plurality of computer-executable instructions which, when executed by a processor, provide a financial management system. The financial management system includes a user interface module configured to provide financial interview content data to a user of a financial management system in a financial management interview via a primary web browser executed by a user computing environment associated with the user. The financial management system includes an embedded browser execution module configured to implement an embedded web browser in a tab of the primary web browser, to access the third-party website via the embedded web browser, and to assist the user to retrieve financial document data related to a financial document of the user from the third-party website via the embedded web browser during the financial management interview.

In one embodiment, a system facilitates the efficient and convenient retrieval of financial document data within a financial management interview. The system includes at least one processor and at least one memory coupled to the at least one processor. The at least one memory having stored therein instructions which, when executed by any set of the one or more processors, perform a process including initiating a financial management interview with a user of a financial management system via a primary web browser executed in a user computing environment associated with the user and presenting financial management interview content data to the user via the primary web browser. The process includes inviting the user to provide current user tax related data to the financial management system via the primary web browser determining that the user needs to retrieve financial document data from a third-party website. The process includes initiating an embedded web browser in the primary web browser and inviting the user to access financial document data from the third-party website via the embedded web browser. The process includes generating user action tracking data by tracking actions taken by the user to access the financial document data with the embedded web browser and downloading the financial document data to the financial management system when the user selects to download the financial document data via the embedded web browser.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

As discussed in more detail above, using the above embodiments, with little or no modification and/or input, there is considerable flexibility, adaptability, and opportunity for customization to meet the specific needs of various parties under numerous circumstances.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “adding”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “eliminating”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “substituting”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIGS., or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A system for facilitating the efficient and convenient retrieval of financial document data within a financial management interview, the system comprising:
at least one processor; and
at least one memory coupled to the at least one processor, the at least one memory having stored therein instructions which, when executed by any set of the one or more processors, perform a process including:
initiating a tax return preparation interview with a user of a tax return preparation system via a primary web browser executed in a user computing environment associated with the user;
presenting tax return preparation interview content data to the user via the primary web browser;
inviting the user to provide current user tax related data to the tax return preparation system via the primary web browser;
determining that the user needs to retrieve tax related document data from a third-party website;
initiating an embedded web browser in the primary web browser;
inviting the user to access tax related document data from the third-party website via the embedded web browser;
generating user action tracking data by tracking actions taken by the user to access the tax related document data with the embedded web browser; and
downloading the tax related document data to the tax return preparation system when the user selects to download the tax related document data via the embedded web browser.

2. The system of claim 1, wherein the process includes providing notification data including a notification related to the download of the tax related document data in the primary web browser.

3. The system of claim 2, wherein the notification includes indicates progress of the download.

4. The system of claim 2, wherein the notification indicates that the download has completed successfully.

5. The system of claim 2, wherein the notification indicates that the download has failed.

6. The system of claim 2, wherein the notification indicates that the downloaded tax related document data corresponds to the wrong document.

7. The system of claim 1, wherein the process further includes automatically populating data fields of a tax form based on the tax related document data.

8. The system of claim 1, wherein the process further includes generating script data for automatically retrieving tax related document data from the third-party website via the embedded web browser based at least in part on the user action tracking data.

9. The system of claim 8, wherein the process includes generating the script data based on user action tracking data related to actions of a plurality of users that have accessed respective user tax related document data

10. The system of claim 9, further comprising, after generating the script data:
initializing a tax return preparation interview with a second user via a primary web browser executed in a user computing environment of the second user;
providing tax return preparation interview content data to the second user via the primary web browser executed in the user computing environment of the second user;
initiating a second embedded web browser in the in the web browser executed in the user computing environment of the second user;
accessing the third-party website via the second embedded web browser; and
automatically retrieving user tax related document data of the second user from the third-party website by executing the script data.

11. The system of claim 10, wherein the process further includes executing the script in the second embedded web browser after the second user provides authentication data to the third-party website via the second embedded web browser.

12. The system of claim 8, wherein the script data includes HTML script data.

13. The system of claim 1, wherein accessing the third-party website via the embedded web browser includes accessing an authentication page of the third-party website.

14. The system of claim 1, wherein the tax related document data includes one or more of:
employee income;
taxes withheld;
miscellaneous income;
mortgage interest paid;
student loan interest paid;
retirement accounts;
dividends received;
health insurance payments;
medical payments;
interest income;
tuition paid;
student loan interest paid;
proceeds from broker transactions;
taxable distributions received;
distributions from pensions;
proceeds from real estate transactions; and
distributions from a health savings account.

15. The system of claim 1, wherein the tax return preparation interview content data includes tax topics to be presented to the user.

16. The system of claim 14, wherein tax return preparation interview content data includes tax related questions.

17. The system of claim 1, wherein the process includes determining that the user needs to retrieve tax related document data from the third-party website based on the current user tax related data provided by the user.

18. The system of claim 1, wherein the embedded web browser is presented to the user in a tab of the primary web browser through which the tax return preparation interview is presented to the user.

19. A computing system implemented method for facilitating the efficient and convenient retrieval of financial document data within a financial management interview, the method comprising:
initiating a financial management interview with a user of a financial management system via a primary web browser executed in a user computing environment associated with the user;
presenting financial management interview content data to the user via a tab of the primary web browser;
inviting the user to provide current user financial data to the financial management system via the primary web browser;
determining that financial document data of the user needs to be retrieved from a third-party website;
implementing an embedded web browser in the tab of the primary web browser;
accessing the third-party website via the embedded web browser;
prompting the user to provide authentication data to the third-party website via the embedded web browser; and
after the user has provided authentication data to the third-party website via the embedded web browser, automatically downloading the tax related document data to the tax return preparation system by executing script data.

20. The system of claim 19, wherein the process further includes selecting the automated script from a script data based including a plurality of automated scripts for downloading various financial document data from various third-party websites.

21. The system of claim 19, wherein the process further includes generating user action tracking data based on actions of a plurality of users of the financial management system that previously accessed financial document data from the third-party website via the embedded web browser.

22. The system of claim 21, wherein the process further incudes generating the automated script base on the user action tracking data.

23. The system of claim 19, wherein the financial management system is a tax return preparation system.

24. The system of claim 19, wherein the process includes providing notification data including a notification related to the download of the tax related document data in the primary web browser.

25. The system of claim 24, wherein the notification includes indicates progress of the download.

26. The system of claim 24, wherein the notification indicates that the download has completed successfully.

27. The system of claim 24, wherein the notification indicates that the download has failed.

28. The system of claim 24, wherein the notification indicates that the downloaded tax related document data corresponds to the wrong document.

29. The system of claim 19, wherein the process further includes automatically populating data fields of a tax form based on the tax related document data.

30. A non-transitory computer-readable medium having a plurality of computer-executable instructions which, when executed by a processor, provide a financial management system including:
a user interface module configured to provide financial interview content data to a user of a financial management system in a financial management interview via a primary web browser executed by a user computing environment associated with the user;
an embedded browser execution module configured to implement an embedded web browser in a tab of the primary web browser, to access the third-party website via the embedded web browser, and to assist the user to retrieve financial document data related to a financial document of the user from the third-party website via the embedded web browser during the financial management interview.

31. The non-transitory computer-readable medium of claim 30, wherein the embedded browser execution module is configured to open the embedded web browser to an authentication page of the third-party website.

32. The non-transitory computer-readable medium of claim 31, wherein the embedded browser execution module is configured to enable the user to navigate the third-party website via the embedded web browser and to select to download the financial document data via the embedded web browser.

33. The non-transitory computer-readable medium of claim 32, wherein the embedded browser execution module is configured to download the financial document data to the financial management system.

34. The non-transitory computer-readable medium of claim 31, wherein the financial management system includes a script generation module configured to generate script data for automatically downloading financial document data from the third-party website based on user action tracking data including actions taken by previous users of the financial management system to download financial document data from the third-party website via the embedded web browser.

35. The non-transitory computer-readable medium of claim 34, wherein the embedded browser execution module is configured to, after the user has provided authentication data to the third-party website via the embedded web browser, automatically download the financial document data to the tax return preparation system by executing script data.

36. A system for facilitating the efficient and convenient retrieval of financial document data within a financial management interview, the system comprising:
at least one processor; and
at least one memory coupled to the at least one processor, the at least one memory having stored therein instructions which, when executed by any set of the one or more processors, perform a process including:
initiating a financial management interview with a user of a financial management system via a primary web browser executed in a user computing environment associated with the user;
presenting financial management interview content data to the user via the primary web browser;
inviting the user to provide current user tax related data to the financial management system via the primary web browser;
determining that the user needs to retrieve financial document data from a third-party website;
initiating an embedded web browser in the primary web browser;
inviting the user to access financial document data from the third-party website via the embedded web browser;
generating user action tracking data by tracking actions taken by the user to access the financial document data with the embedded web browser; and
downloading the financial document data to the financial management system when the user selects to download the financial document data via the embedded web browser.

37. The system of claim 36, wherein the process includes providing notification data including a notification related to the download of the financial document data in the primary web browser.

38. The system of claim 37, wherein the notification includes indicates progress of the download.

39. The system of claim 37, wherein the notification indicates that the download has completed successfully.

40. The system of claim 37, wherein the notification indicates that the download has failed.

41. The system of claim 37, wherein the notification indicates that the downloaded financial document data corresponds to the wrong document.

42. The system of claim 36, wherein the process further includes automatically populating data fields of a tax form based on the financial document data.

43. The system of claim 35, wherein the process further includes generating script data for automatically retrieving financial document data from the third-party website via the embedded web browser based at least in part on the user action tracking data.

44. The system of claim 43, wherein the process includes generating the script data based on user action tracking data related to actions of a plurality of users that have accessed respective user financial document data

45. The system of claim 44, further comprising, after generating the script data:
initializing a financial management interview with a second user via a primary web browser executed in a user computing environment of the second user;
providing financial management interview content data to the second user via the primary web browser executed in the user computing environment of the second user;
initiating a second embedded web browser in the in the web browser executed in the user computing environment of the second user;
accessing the third-party website via the second embedded web browser; and
automatically retrieving user financial document data of the second user from the third-party website by executing the script data.

46. The system of claim 45, wherein the process further includes executing the script in the second embedded web browser after the second user provides authentication data to the third-party website via the second embedded web browser.

47. The system of claim 43, wherein the script data includes HTML script data.

48. The system of claim 36, wherein accessing the third-party website via the embedded web browser includes accessing an authentication page of the third-party website.

49. The system of claim 36, wherein the financial document data includes one or more of:
employee income;
taxes withheld;
miscellaneous income;
mortgage interest paid;
student loan interest paid;
retirement accounts;
dividends received;
health insurance payments;
medical payments;
interest income;
tuition paid;
student loan interest paid;
proceeds from broker transactions;
taxable distributions received;
distributions from pensions;
proceeds from real estate transactions; and
distributions from a health savings account.

50. The system of claim 36, wherein the financial management interview content data includes tax topics to be presented to the user.

51. The system of claim 50, wherein financial management interview content data includes tax related questions.

52. The system of claim 36, wherein the process includes determining that the user needs to retrieve financial document data from the third-party website based on the current user tax related data provided by the user.

53. The system of claim 36, wherein the embedded web browser is presented to the user in a tab of the primary web browser through which the financial management interview is presented to the user.
